(19) United States
(12) Patent Application Publication
(10) Pub. No.: US 2008/0253109 A1
(43) Pub. Date: Oct. 16, 2008

(54) Automotive headlamp with strap-receiving compartment

(75) Inventors: Serafino Sal Canino, Torrington, CT (US); Scott Gelormino, Burlington, CT (US)

Correspondence Address: BROWN RUDNICK LLP, ONE FINANCIAL CENTER, BOSTON, MA, 02111, US

(73) Assignee: ICC Innovative Concepts Corp., Torrington, CT (US)

(21) Appl. No.: 11/786,657

(22) Filed: Apr. 11, 2007

(51) Int. Cl. F21V 21/084; B60Q 1/00

(52) U.S. Cl. 362/105; 362/193

(57) ABSTRACT

A light housing member and a generator housing member configured and dimensioned to be mechanically attached to the light housing member in a first closed light emitting apparatus configuration is disclosed. The generator housing member defines a cavity. A strap assembly is configured to extend around the head of a user. The strap assembly is attached to the light housing member. A rechargeable battery is mechanically associated with the light housing member. An electrically driven light source is mechanically associated with the light housing member. The light source is positioned to output light from the light housing member. A generator is mechanically associated with the generator housing member. A crank is mechanically coupled to the generator. A generator housing member electrical connector is electrically coupled to the generator. A light housing member electrical connector is electrically coupled to the electrically driven light source. The light housing member electrical connector mates with and electrically couples to the generator housing member electrical connector when the light housing member and the generator housing member are mechanically attached to each other.

### TECHNICAL FIELD

The present invention relates to automotive work lights which allow convenient and variable aiming of light, while also allowing the two hands of the user to perform a task under illumination.

### BACKGROUND

The performance of various tasks under poor lighting conditions and potentially dangerous situations, such as those encountered in automotive applications presents special challenges. For example, it is not uncommon for an automobile to fail while being driven on a highway late at night in an area where the road lighting is nonexistent or poor. Under such circumstances, a fan belt may snap and need to be replaced, a leak in steering fluid may require refilling the steering fluid reservoir as a temporary fix to allow enough drive time to reach a service station where a proper repair can be made, or some other minor, or perhaps not so minor, matter may need to be addressed on the road.

During such an occurrence, a driver may need to leave his car and address the problem. Usually, this will involve some inspection of the mechanical equipment and perhaps the making of a permanent or temporary fix. However, inspection of the problem requires good visibility of the mechanical systems causing the problem and, accordingly, good lighting conditions. In the context of automotive situations, good lighting is particularly important, because poor lighting may cause problems which cause the individual making a repair to be overly focused on the particular mechanical system under inspection and fail to adequately monitor traffic conditions and the dangers they pose.

Typically, the issue of illumination of automotive systems on the road is addressed by a common flashlight/head-mounted light. Such flashlight/head-mounted lights, while capable of providing proper light, under the best conditions, often fail to perform with ease and reliability.

### SUMMARY OF THE INVENTION

More particularly, automotive lights must be held and aimed. This means that at least one hand of the user must be occupied holding the flashlight. While this is generally sufficient for purposes of inspection of, for example, an automotive system, the solution is not practical in the context of servicing a system. More particularly, in order to service most systems, it is desirable to have two hands free to work. Accordingly, in order to achieve this result, it is not unusual for an individual to put the flashlight/head-mounted light down on a surface at a position selected to illuminate the situs of the work or inspection. While, perhaps, this is better than the situation where an individual has only one hand free to do some work, the result is seldom satisfactory from the standpoint of the quality of lighting achieved.

In an attempt to address this situation, various alternatives have been proposed. For example, attachment of a strap to a flashlight/head-mounted light and hanging the same from, for example, an open automobile hood or a convenient object, such as a tree, will provide some degree of control of position. However, such approaches are far from satisfactory and are also difficult to implement.

Moreover, even if such an approach can provide adequate lighting and freedom for the hands to work, a flashlight/head-mounted light stored in the trunk of a car, for example, may suffer from a number of problems. For example, the battery may be dead. Moreover, it is not practical to use a conventional rechargeable flashlight/head-mounted light which would be plugged into, for example, the electrical mains of a house, ready for use because no such ready source of electricity is available. Worse, the conventional flashlight/head-mounted light battery may be deteriorated to the point where it has begun to leak and ooze battery acid, resulting in potentially serious damage to the floor of the trunk, glove compartment or other area where it is stored and/or damage to objects located proximate to the position of storage of the flashlight/head-mounted light.

It is an objective of the present invention to address these problems by providing a reliable light source which does not pose a threat of potential damage, is always ready to be used, and is easy to operate, while at the same time allows for hands-free operation. The objects satisfied by the invention also include a compact one-piece package, not dissimilar to a conventional flashlight, and an overall system configuration which reduces the likelihood of worn or missing parts.

In accordance with the invention, the above objects are achieved through the provision of a work light which comprises a light housing member and a generator housing member configured and dimensioned to be mechanically attached to the light housing member in a first closed light emitting apparatus configuration. The generator housing member defines a cavity. A strap assembly is configured to extend around the head of a user. The strap assembly is attached to the light housing member. A rechargeable battery is mechanically associated with the light housing member. An electrically driven light source is mechanically associated with the light housing member. The light source is positioned to output light from the light housing member. A generator is mechanically associated with the generator housing member. A crank is mechanically coupled to the generator. A generator housing member electrical connector is electrically coupled to the generator. A light housing member electrical connector is electrically coupled to the electrically driven light source. The light housing member electrical connector mates with and electrically couples to the generator housing member electrical connector when the light housing member and the generator housing member are mechanically attached to each other.

The electrically driven light source is coupled to the light housing member electrical connector by an on off switch. The crank conforms generally to the outside surface of an overall housing shape defined by the light housing member and the generator housing member.

The crank is mechanically coupled to the generator by an elongated gear train extending along the length of an overall housing defined by the light housing member and the generator housing member. The overall housing is elongated in shape.

### BRIEF DESCRIPTION OF THE DRAWINGS

The operation, features and use of the invention will be understood from the description which appears below, taken together with the following drawings showing only one exemplary embodiment of the invention, and in which:

FIG. 1 is a perspective view of the inventive flashlight/head-mounted light;

FIG. 2 is a plan view of the flashlight/head-mounted light illustrated in FIG. 1;

FIG. 3 is a side view of the inventive flashlight/head-mounted light;

FIG. 4 is a rearview of the inventive flashlight/head-mounted light;

FIG. 5 is a front view of the inventive flashlight/head-mounted light showing the lenses through which light is produced by the flashlight/head-mounted light;

FIG. 6 shows disassembly of the inventive flashlight/head-mounted light in order to release the head support strap system;

FIG. 7 illustrates the inventive system being used as a head lamp;

FIG. 8 is a perspective view from the rear of the inventive flashlight/head-mounted light showing the crank handle;

FIG. 9 illustrates the inventive flashlight/head-mounted light with the crank handle in the battery charging position;

FIG. 10 is a top plan view of an alternative embodiment of the inventive flashlight containing a head lamp;

FIG. 11 is a perspective view of the inventive flashlight/head-mounted light illustrated in FIG. 10 showing the flashlight with the head lamp containing a compartment open; and

FIG. 12 is an exploded perspective of the flashlight of FIG. 10 showing the removal of the head lamp.

### DETAILED DESCRIPTION OF THE PREFERRED EMBODIMENT

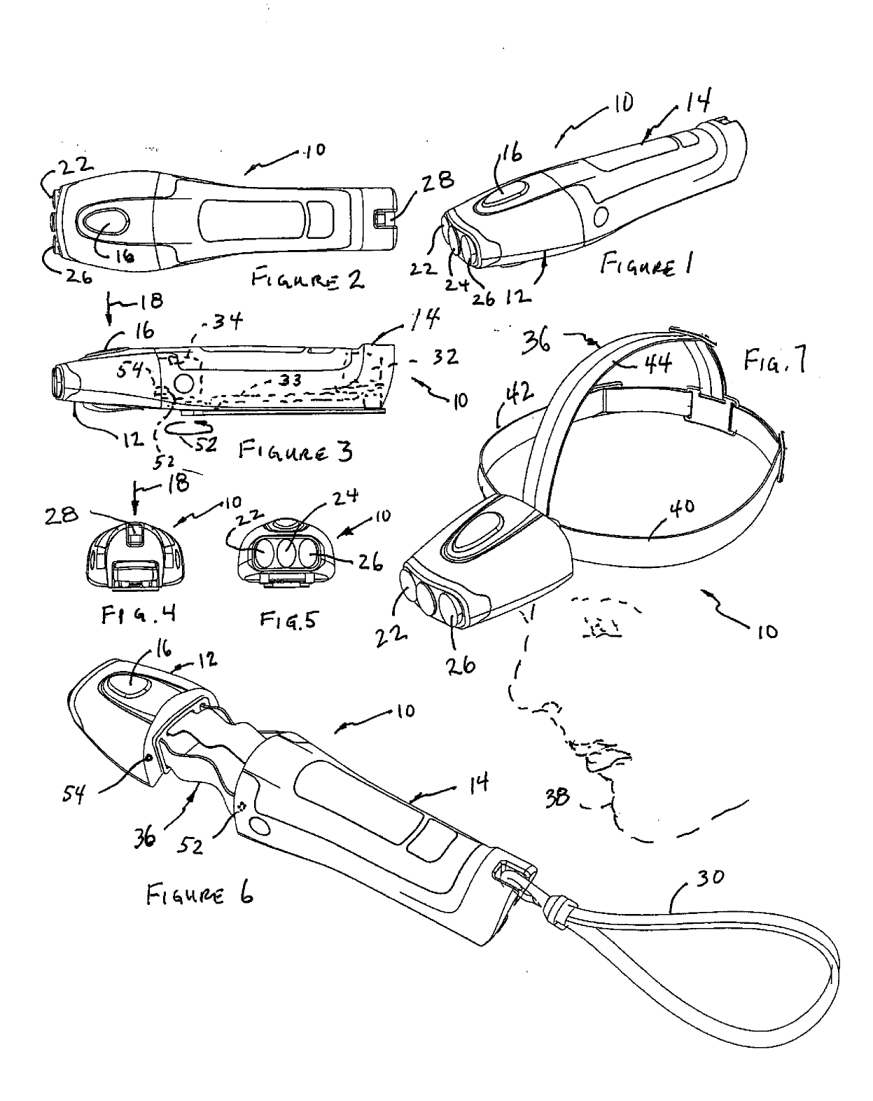

Referring to FIGS. 1-2, a flashlight/head-mounted light 10 constructed in accordance with the present invention is illustrated. Flashlight/head-mounted light 10 comprises a light housing 12 and a charger housing 14.

Light housing 12 and charger housing 14 may be made to mechanically join to each other using a conventional snap fit, a friction fit or more elaborate configuration incorporating, for example, a locking screw, latch (such as those used to secure removable members in laptop computers) or the like. When charger housing 14 and light housing 12 are joined to each other, they can be used as an ordinary one-piece flashlight. In addition to this, light housing 12 and charger housing 14 may be separated from each other to expose a strap for mounting light housing 12 against the forehead of a user for use as a headmounted light, as more fully appears below.

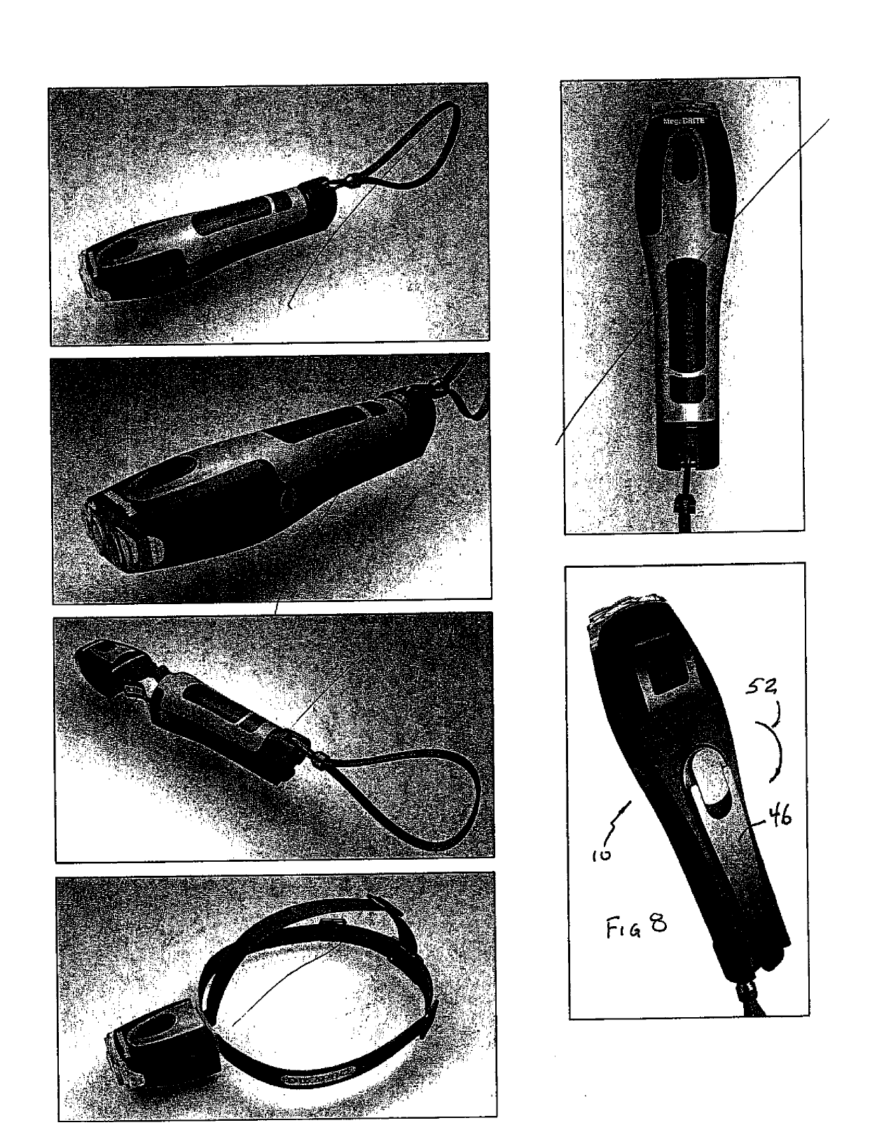

Light housing 12 includes an off switch 16 which may be used to turn the flashlight/head-mounted light on and off in a manner typical of the prior art, and/or to vary the number of lights which are turned on. For example, one depression, in the direction of arrow 18 (FIGS. 3-4), of switch 16 may turn the central light of, for example, a three light array on; a second depression of switch 16 may illuminate all three lights; and the third depression of switch 16 may return the flashlight/head-mounted light to the off position. The electrical circuits for flashlight/head-mounted lights of this type are known in the prior art. See, for example, the U.S. Pat. No. 6,959,999 entitled “Flashlight Having Manual Charging Device” of Wen Sung Lee which was issued on Nov. 1, 2005. It is further noted that the configuration of lights, actuation sequence of lights and the number of lights may be varied in accordance with the invention.

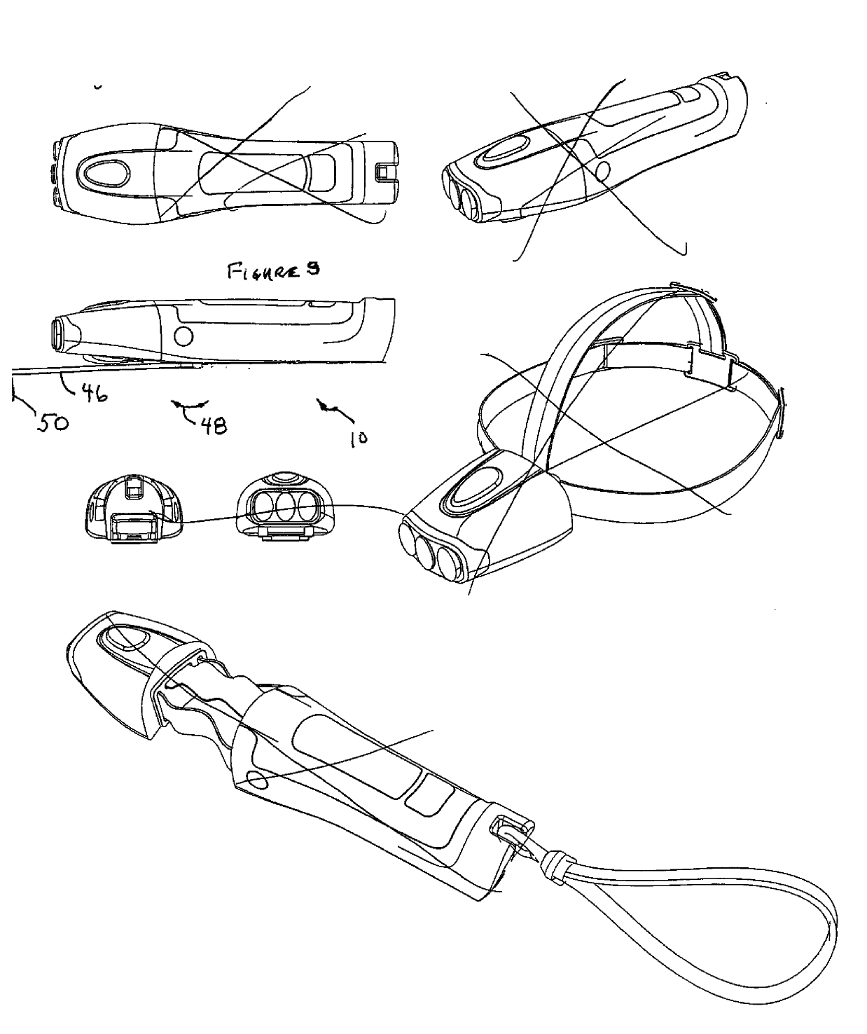

Light is produced by a group of three light emitting diodes and output from flashlight/head-mounted light 10 through a plurality of lenses 22, 24 and 26, as illustrated most clearly in FIG. 5. A post 28 allows the attachment of strap 30, as illustrated most clearly in FIG. 6. It is noted that the strap is not illustrated in FIGS. 1, 2, 3 and 4, for purposes of clarity of illustration.

Generally, light housing 12 houses mechanics of electrical switch 16, the light emitting diodes, a storage battery and a reflective light assembly such as is illustrated in U.S. Pat. No. 6,959,999 of Wen Sung Lee. Charger housing 14 houses a generator 32 (FIG. 3) and an elongated gear train 33 assembly similar to that disclosed in U.S. Pat. No. 6,959,999 of Wen Sung Lee.

The forward portion of charger housing 14 defines a cavity 34 (FIG. 3) for housing a head strap assembly. When light housing 12 is separated from charger housing 14, as illustrated in FIG. 6, such a head strap assembly 36 is revealed.

Referring to FIG. 7, when it is desired to use the inventive flashlight/head-mounted light as a head lamp (as opposed to as a simple flashlight/head-mounted light by simply pressing switch button 16 with the flashlight/head-mounted light in the configuration shown in FIG. 1), light housing 12 is separated from charger housing 14. This results in strap assembly 36 being pulled out of cavity 34. Strap assembly 36 may then be placed over the head 38 of a user, as illustrated in FIG. 7. In use, cooperating headband members 40 and 42 are adjusted to be snug around the forehead and the back of the head of the user, while at the same time allowing top band 44 to fit over the top of the head.

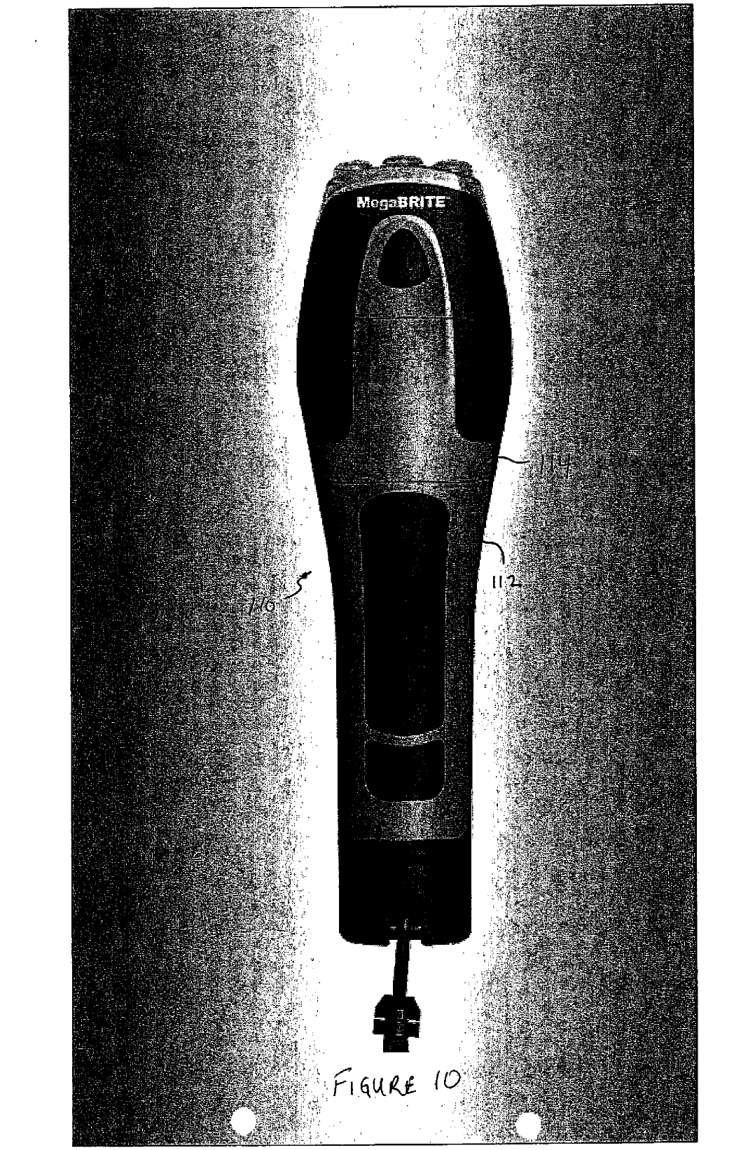

Charging of a rechargeable battery located in light housing 12 is provided by generator 32 which is coupled to crank handle 46 by a conventional gear train 33, as disclosed above. As illustrated in FIG. 9, crank handle 46 is rotated in the direction of arrows 48 to place crank handle 46 in the cranking position illustrated in FIG. 9. In this configuration, grasping of knob 50, which is rotatably mounted on crank handle 46 allows the user to rotate crank handle 46 in the conventional manner of U.S. Pat. No. 6,959,999 of Wen Sung Lee, as illustrated by arrow 52 in FIG. 8. See also FIG. 3. charging by rotating crank handle 46 should be done with the flashlight/head-mounted light 10 in the position illustrated in FIG. 1, so that power may be coupled from the generator section in charger housing 14 to a rechargeable battery in light housing 12.

In accordance with the present invention, the raw output of generator 32 may be coupled by an output electrical coupling 52 to an input electrical coupling 54. Coupling 54 may be coupled to a circuit board which contains the necessary electronics to convert the output of generator 32 to a dc waveform for charging a storage battery in light housing 12. When cranking has been completed and the battery satisfactorily charged, crank handle 46 may be returned to the position illustrated in FIG. 3. Coupling 54 electrically and mechanically mates with coupling 52 when inventive flashlight/head-mounted light 10 is in the position illustrated in FIG. 1. Conversely, when light housing 12 is separated from charger housing 14, coupling 52 is separated from coupling 54 and rotation of crank handle 46 will not charge the rechargeable battery in light housing 12.

Alternatively, the charger circuit may be housed in light housing 12 and the raw alternating current output of charger 32 coupled by couplings 52 and 54 to the circuit, which is, in turn, coupled to the rechargeable battery when flashlight/head-mounted light 10 is in the position illustrated in FIG. 1.

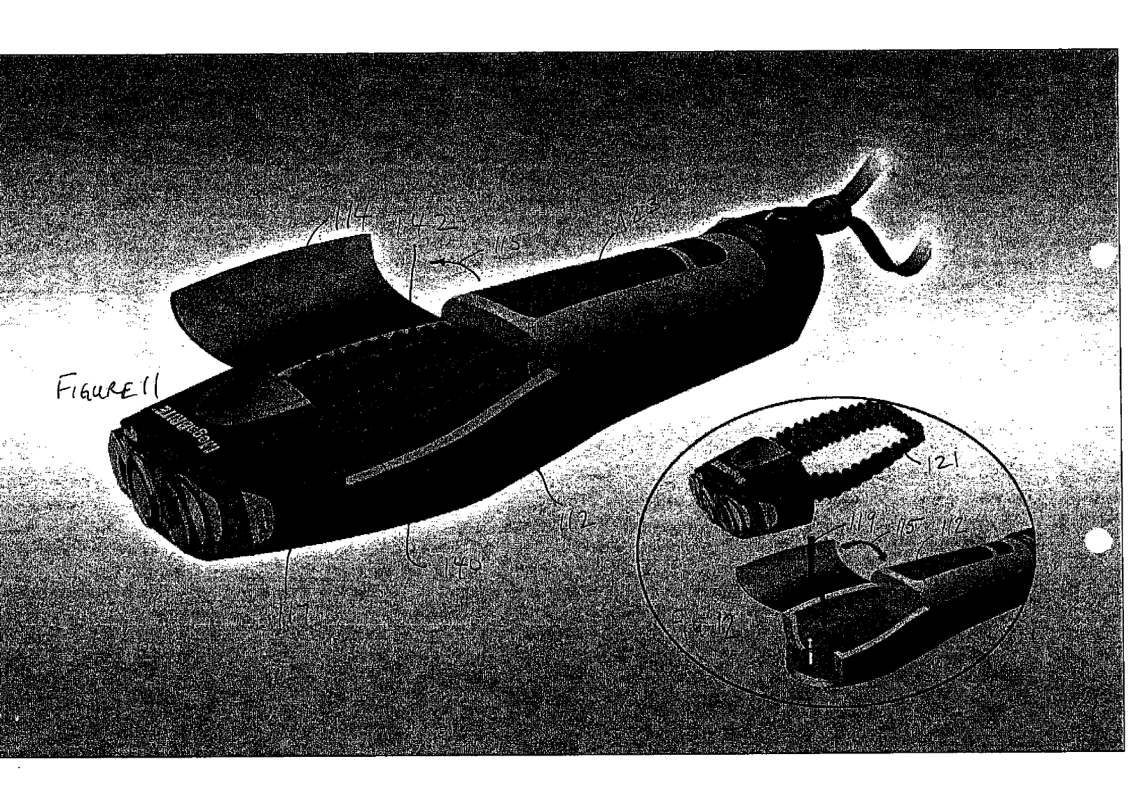

Preferring to FIG. 10, an alternative embodiment of the inventive flashlight 110 is illustrated. Flashlight 110 includes an outer casing 112 and a hinged openable lid 114. As illustrated in FIG. 11, lid 114 may be opened by rotation in the direction indicated by arrow 115. The result is to expose the straps 140 and 142 of the headlamp. The system further includes a top strap 144.

Opening the lid as illustrated in FIG. 11 allows the removal of the headlamp assembly 117. In accordance with the preferred embodiment of the invention, the rear portion 121 of the head straps may extend into the rear portion 123 of housing 112. Headlamp assembly 117 may then be slid from housing 112, or replaced therein by placing in outer casing 112 by moving in the direction of arrow 119, as illustrated in FIG. 12. When detached as illustrated in FIG. 12, the head lamp may be used as illustrated in FIG. 7.

While an illustrative embodiment of the invention has been described, it is understood that various modifications will be obvious to those of ordinary skill in the art. Such modifications are within the spirit and scope of the invention which is limited and defined only by the appended claims.

1. A flashlight, comprising:
(a) an elongated housing having a housing height, a housing width and a housing length, said housing length extending between a first housing end and a second housing end, said housing height and said housing width defining a cross-section small enough to be grasped by the hand of a user, said housing comprising:
(i) a light housing member;
(ii) a generator housing member configured and dimensioned to be mechanically attached to said light housing member in a first closed light admitting apparatus configuration, said generator housing member defining a cavity;
(b) a light emitting device positioned at said first housing end;
(c) an elongated gear train having first and second ends and having a length and a width, the length of said gear train extending along the length of said housing, said elongated gear train being positioned within said housing;
(d) a generator coupled to one end of said elongated gear train;
(e) a crank coupled to the other end of said gear train for applying rotary torque to said elongated gear train; and
(f) a strap assembly configured to extend around the head of a user, said strap assembly being attached to said light housing member.

2. A flashlight as in claim 1, wherein said generator is an electrical generator.

3. A flashlight as in claim 1, wherein said gear train comprises a plurality of gears supported for rotation within said housing.

4. A flashlight as in claim 3, wherein said crank is coupled to one of said gears by a pivot member coupled to said one of said gears, said crank comprising a mounting portion that is rotatably supported on said pivot member, and said housing defines a surface for retaining said crank in position.

5. A flashlight as in claim 4, wherein said pivot member is a pin.

6. A flashlight as in claim 5, wherein said mounting portion comprises a pair of fingers that receive opposite ends of said pin.

7. A flashlight, comprising:
(a) an elongated housing having a housing height, a housing width and a housing length, said housing length extending between a first housing end and a second housing end, said housing height and said housing width defining a cross-section small enough to be grasped by the hand of a user, said housing comprising:
(i) a light housing member;
(ii) a generator housing member configured and dimensioned to be mechanically attached to said light housing member in a first closed light admitting apparatus configuration, said generator housing member defining a cavity;
(b) a light emitting device positioned at said first housing end;
(c) a gear train having first and second ends, said gear train being positioned within said housing;
(d) a generator coupled to one end of said gear train;
(e) a crank coupled to the other end of said gear train for applying rotary torque to said gear train, wherein said crank is coupled to one of said gears by a pivot support member coupled to said one of said gears, said crank comprising a mounting portion that is rotatably supported on said pivot support member, and said housing defining a surface for retaining said crank in position; and
(f) a strap assembly configured to extend around the head of a user, said strap assembly being attached to said light housing member.

8. A flashlight as in claim 7, wherein said pivot member is a pin.

9. A flashlight as in claim 8, wherein said mounting portion comprises a pair of fingers that receive opposite ends of said pin.

10. A flashlight as in claim 7, wherein said generator is an electrical generator.

11. A flashlight as in claim 7, wherein said gear train comprises a plurality of gears supported for rotation within said housing.

12. A flashlight, comprising:
(a) an elongated housing having a housing height, a housing width and a housing length, said housing length extending between a first housing end and a second housing end, said housing height and said housing width defining a cross-section small enough to be grasped by the hand of a user, said housing comprising:
(i) a light housing member;
(ii) a generator housing member configured and dimensioned to be mechanically attached to said light housing member in a first closed light admitting apparatus configuration, said generator housing member defining a cavity;
(b) a light emitting device positioned at said first housing end;
(c) an elongated gear train having first and second ends and having a length and a width, the length of said gear train extending along the length of said housing, said elongated gear train being positioned within said housing;
(d) a generator coupled to the first end of said elongated gear train;
(e) a crank coupled to the second end of said gear train for applying rotary torque to said elongated gear train;
(f) a rechargeable battery for receiving power from said generator and coupled to said light emitting device to provide power to said light emitting device;
(g) an electrical circuit positioned over said gear train, said electrical circuit coupled to said rechargeable battery; and
(f) a strap assembly configured to extend around the head of a user, said strap assembly being attached to said light housing member.

13. A flashlight as in claim 12, wherein said generator is an electrical generator.

14. A flashlight as in claim 12, wherein said crank is coupled to one of said gears by a pivot member coupled to said one of said gears, said crank comprising a mounting portion that is rotatably supported on said pivot member, and said housing defines a surface for retaining said crank in position.

15. A flashlight as in claim 14, wherein said pivot member is a pin.

16. A flashlight as in claim 15, wherein said mounting portion comprises a pair of fingers that receive opposite ends of said pin.

17. A flashlight as in claim 16, wherein said circuit forms a multilayer structure with said pivot member.

18. A flashlight as in claim 12 wherein said circuit forms a multilayer structure with said pivot member.

19. A flashlight as in claim 12, wherein said crank is coupled to said second end of said gear train by a pivot support member coupled to a gear in said gear train, said crank comprising a mounting end that is rotatably supported on said pivot support member, and said housing defining a surface for retaining said crank in position.

20. A flashlight as in claim 19 wherein said crank comprises a cranking end, opposite said mounting end, and further comprising a knob rotatably attached to said cranking end to allow said crank to be rotated relative to said housing.

21. A light emitting apparatus, comprising:
(a) a light housing member;
(b) a generator housing member configured and dimensioned to be mechanically attached to said light housing member in a first closed light admitting apparatus configuration, said generator housing member defining a cavity;
(c) a strap assembly configured to extend around the head of a user, said strap assembly being attached to said light housing member;
(d) a rechargeable battery mechanically associated with said light housing member;
(e) an electrically driven light source mechanically associated with said light housing member, said light source being positioned to output light from said light housing member;
(f) a generator mechanically associated with said generator housing member;
(g) a crank mechanically coupled to said generator;
(h) a generator housing member electrical connector electrically coupled to said generator; and
(i) a light housing member electrical connector electrically coupled to said electrically driven light source, said light housing member electrical connector mating with and electrically coupling to said generator housing member electrical connector when said light housing member and said generator housing member are mechanically attached to each other.

22. A light emitting apparatus as in claim 21, wherein said electrically driven light source is coupled to said light housing member of electrical connector by and on off switch.

23. A light emitting apparatus as in claim 21, wherein said crank conforms generally to the outside surface of an overall housing defined by said light housing member and said generator housing member.

24. A light emitting apparatus as in claim 21, wherein said crank is mechanically double to said generator by an elongated year train extending along the length of an overall housing defined by said light housing member and said generator housing member, said overall housing being elongated in shape.

25. A light emitting apparatus as in claim 21, wherein said light housing member contains a battery and said light source, and may be detached from a main body housing.
